(19) United States
(12) Patent Application Publication
(10) Pub. No.: US 2007/0252842 A1
(43) Pub. Date: Nov. 1, 2007

(54) System and method for capturing and transposing vertically scanned documents in an imaging system

(76) Inventors: Gerald R. Smith, Farmington, MI (US); William L. Kozlowski, Novi, MI (US)

Correspondence Address: UNISYS CORPORATION, UNISYS WAY, MAIL STATION: E8-114, BLUE BELL, PA, 19424, US

(21) Appl. No.: 11/789,333

(22) Filed: Apr. 24, 2007

Related U.S. Application Data
(60) Provisional application No. 60/795,863, filed on Apr. 28, 2006.

(51) Int. Cl. G06F 12/02

(52) U.S. Cl. 345/544

(57) ABSTRACT

A system and method for capturing and transposing vertically scanned documents in an imaging system uses a paged buffer memory, such as DDR SDRAM. Images are captured in the paged buffer memory by writing the images into memory cells in a series of columns, and images are transposed by reading the images from the memory cells in a series of rows. During transposition, the memory cells are partitioned into a plurality of column groups so that a plurality of consecutive pixels of a digitized image can be written on the same memory page. The image is read from the buffer memory in a series of rows arranged in a plurality of groups of consecutive pixels so that a plurality of consecutive pixels can be read from the same memory page.

### CROSS REFERENCE TO RELATED APPLICATIONS

This application claims priority from U.S. Provisional Patent Application Ser. No. 60/795,863, entitled SYSTEM AND METHOD FOR CAPTURING AND TRANSPOSING VERTICALLY SCANNED DOCUMENTS IN AN IMAGING SYSTEM, filed on Apr. 28, 2006, the entire contents of which are hereby incorporated by reference.

### BACKGROUND OF THE INVENTION

1. Field of the Invention

This invention relates generally to the field of imaging, and more particularly to a system and method for capturing and transposing vertically scanned documents in an imaging system using paged, DDR SDRAM (double-data-rate synchronous dynamic random access memory).

2. Description of the Related Art

In a high performance document imaging system utilizing cameras that scan and digitize the document in an array of bottom to top vertical columns, such as found in the document processing system 10 of FIGS. 1 and 2, it becomes necessary to transpose the captured image into an array of left to right horizontal rows for further image processing and image compression. The document processing system 10 and its image capture subsystem 13 are further described below in the detailed description of the invention.

FIG. 4 offers an overview of a transposition function. Digitized camera pixels for an “m-pixel” wide document are WRITTEN into a memory buffer in an image processor board in the image module hardware in a series of “n-pixel” high columns (shown in the shaded area on the left side of FIG. 4). Once captured, the image is READ from the memory, processed and compressed in a series of “m-pixel” wide rows (shown in the shaded area at the top right of FIG. 4).

Previous implementations of this transposition reserved an M×N section of memory where M was the maximum expected width, m, and N was the maximum expected height, n, of the digitized document. The scan direction of the camera (top-to-bottom or bottom-to-top) and the direction of the camera movement across the paper (left-to-right or right-to-left) determine which of the four corners will be the origin or the location where the first pixel will be stored in the M×N array. For example, in the M×N array in FIG. 5, the origin is at address 0 in the lower left corner of the array. As known in the art, this origin assumes bottom-to-top camera scanning of the document and left-to-right camera movement as the scanning progresses through the document. It should of course be appreciated that the origin can be stationed at any of the other three corners depending on the scan direction of the hardware.

In the example of FIG. 5, the first pixel of the first column of the “m”×“n” document, pixel 00, is placed at address 0. The second pixel, pixel 01, is placed at address M. The third pixel, pixel 02, is placed at address 2M. This process continues for the entire first column. When the second column is captured, the first pixel of the second column, pixel 10, is placed at address 1. The second pixel, pixel 11, is placed at address M+1. When the captured image is extracted from this particular M×N buffer, transposition is accomplished by starting the read operation at the top left corner of the image, pixel 0n (shaded gray), at address n*M. Raster scanning continues by reading this nth row of pixels (0n to mn) from address n*M to address (n+1)*M−1.

In the transposition arrangement of FIG. 5, buffer addresses are incremented by M during write/capture and incremented by one (1) during read/transposition. When transposition is performed using SRAM buffers (as was done with previous implementations of imaging systems), these +M increments were inconsequential since there was no performance penalty when writing (reading) consecutive pixels to (from) addresses that were significantly separated. However, when using double-data-rate synchronous dynamic random access memory (DDR SDRAM), there are performance implications.

As known, DDR SRAM or simply, DDR, is arranged in pages. Pages in DDR are groups of contiguous memory locations. In one embodiment described further herein, pages are comprised of 2048 (2K) contiguous byte locations on 2K address boundaries (e.g 0x0000-0x07FF, 0x0800-0x0FFF, 0x1000-0x17FF, etc.) Successive DDR reads (or writes) to memory locations inside a single page can be executed at a high performance, “double” rate (2 bytes per clock). Once a DDR read (or write) crosses a page boundary, the first access to the new page incurs 9 clock cycles of overhead before the access to memory is successful. Thus, as with synchronous random access memory (SRAM), access to DDR within a page requires little overhead; however, accesses to DDR that cross page boundaries will reduce performance as the DDR “pages.” In the above transposition scheme, when an image is READ and the addresses are incremented by 1, there is no performance degradation. However, in the same transposition scheme, if M is greater than the page width of the DDR, the hardware will have to “page” into DDR for every pixel WRITTEN into DDR, resulting in significant performance degradation. With the conventional transposition algorithm, the high performance of the READ operations, where there is virtually no DDR paging, does not offset the relatively poor performance of the WRITE operations, where nearly every pixel incurs a paging penalty.

What is needed is a transposition scheme that avoids performance degradation where memory is arranged in pages.

### SUMMARY OF THE INVENTION

The present invention provides systems and methods for capturing and transposing vertically scanned documents in an imaging system that uses a paged buffer memory, such as DDR SDRAM.

In one embodiment, images are captured in the paged buffer memory by writing the images into memory cells in a series of columns, and images are transposed by reading the images from the memory cells in a series of rows. A transposition algorithm partitions the memory cells into a plurality of column groups so that a plurality of consecutive pixels of a digitized image can be written on the same memory page. The image is then read from the buffer memory in a series of rows arranged in a plurality of groups of consecutive pixels so that a plurality of consecutive pixels can be read from the same memory page. The transposition scheme also balances the paging hits across WRITE and READ operations in a ratio that maximizes imaging system throughput.

The paged memory can, for example, be DDR SDRAM having a page width of 2K (i.e., 2048 bytes), with the maximum expected width M of the image being 2K or greater. In one embodiment, the maximum expected width M of the image is 2048 pixels, and the paged memory is partitioned into eight, 256 column groups so that groups of eight consecutive pixels can be written on the same memory page. In this embodiment, the maximum expected height N of the image is 1024 pixels, and the paged memory is partitioned into rows arranged in eight groups of 256 consecutive pixels with gaps between each group.

According to one aspect, the present invention provides an imaging system, comprising: a means for scanning and digitizing an image; a paged memory into which the image can be written in a series of columns and from which the image can be read in a series of rows; and a means for partitioning the paged memory into a plurality of column groups so that a plurality of consecutive pixels can be written on the same memory page.

According to another aspect, the present invention provides a method of capturing and transposing an image, comprising: scanning and digitizing an image; writing the digitized image into a paged buffer memory in a plurality of column groups so that a plurality of consecutive pixels are written on the same memory page; and reading the image from the paged buffer memory in a series of rows arranged in a plurality of groups of consecutive pixels so that a plurality of consecutive pixels are read from the same memory page.

According to another aspect, the present invention provides a system for capturing and transposing a scanned image that comprises a memory having memory cells arranged in pages, as well as instructions for writing a digitized image into the memory cells with a plurality of consecutive pixels written on the same memory page.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a schematic illustration of a conventional document processing system.

FIG. 2 is a block diagram illustration of subsystems in a document processing system with an imaging subsystem.

FIG. 3 is a high-level functional block diagram showing the basic functionality and communications paths in an imaging subsystem in the document processing system of FIG. 2.

FIG. 4 is a top-level illustration of a transposition function used in an imaging system.

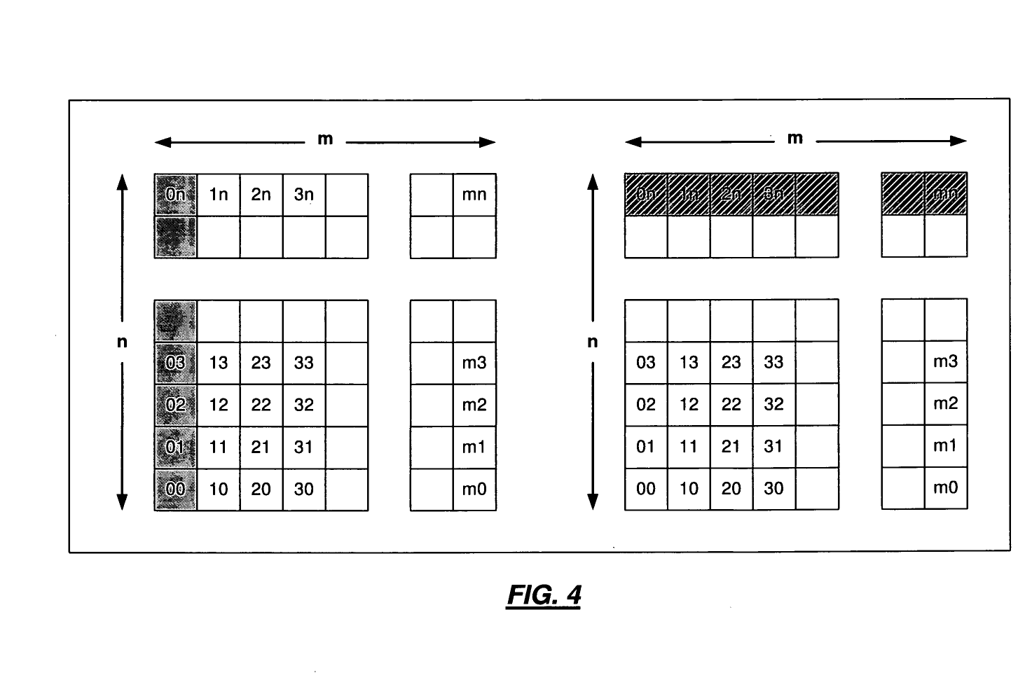

FIG. 5 illustrates a transposition scheme used by imaging systems.

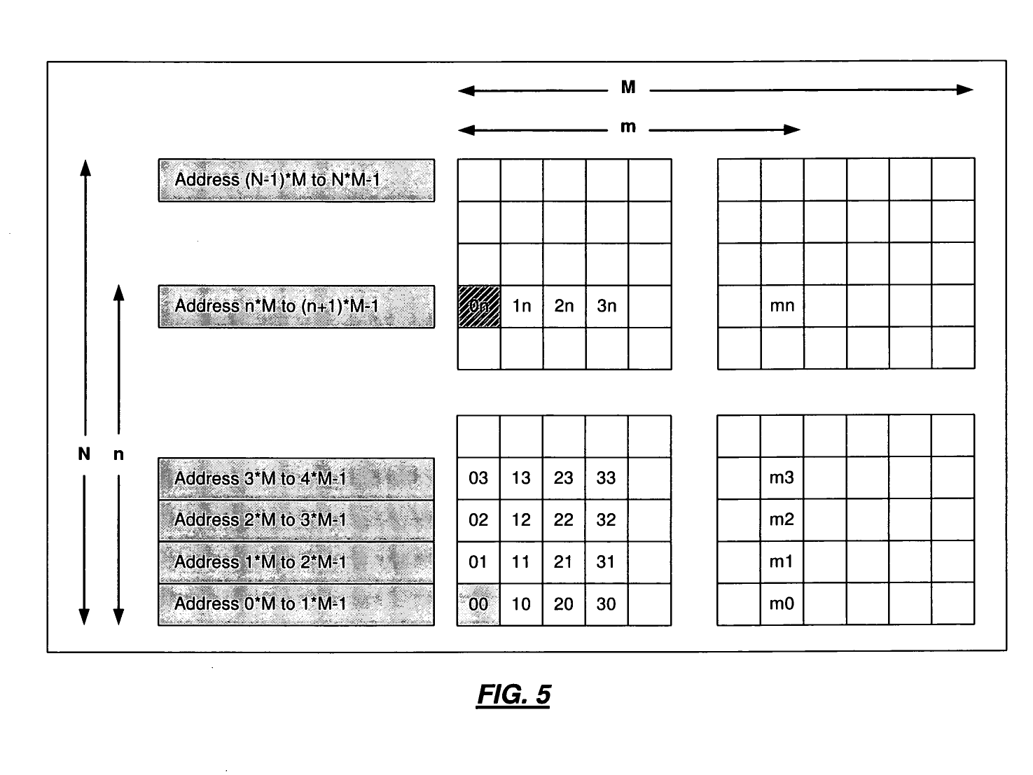

FIG. 6 illustrates a transposition scheme for imaging systems according to the present invention, in which the buffer memory is partitioned into a plurality of column groups.

FIG. 7 is a flowchart of a method for capturing and transposing scanned images in an imaging system according to the present invention.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

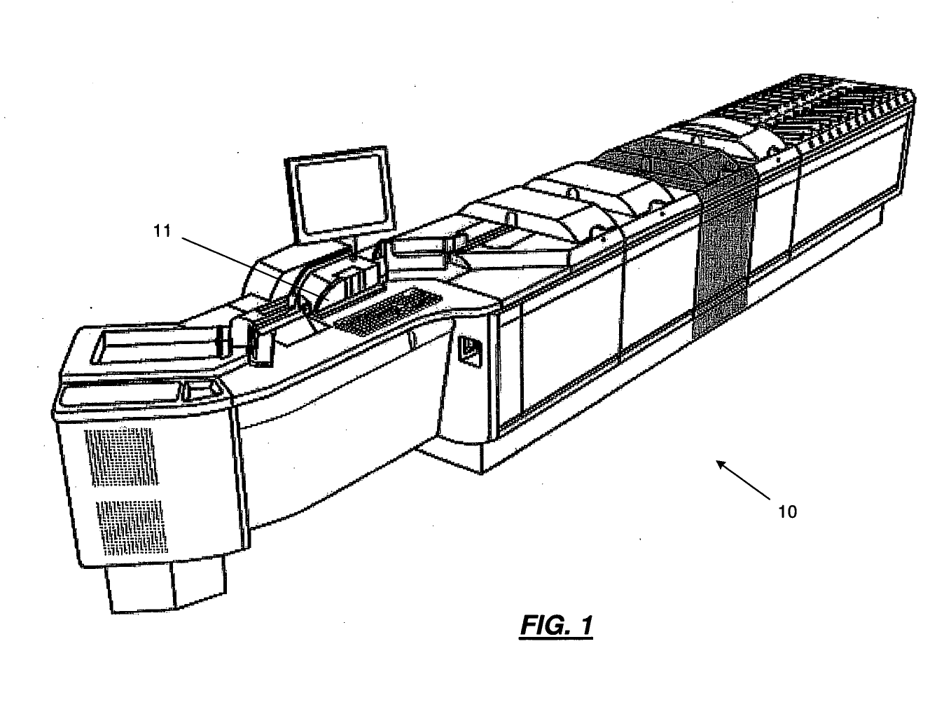

In one embodiment, the present invention is implemented in a document processing system 10, as shown in FIG. 1. The document processing system 10 can be, for example, the SourceNDP, NDP 110, NDP Quantum Series 200, 300 or 600, or NDP Series 850, 1150, 1600, 1825, and 2000 systems, all of which are available commercially from Unisys Corporation, Unisys Way, Blue Bell, Pa. 19424.

As known in the art, a conventional document processing system 10 includes transport hardware 11 with various processing options. The various processing options, when installed, become an integral part of that system's transport mechanism. As the document passes through one of the installed subsystems, the hardware for that installed subsystem performs whatever function it was designed to perform.

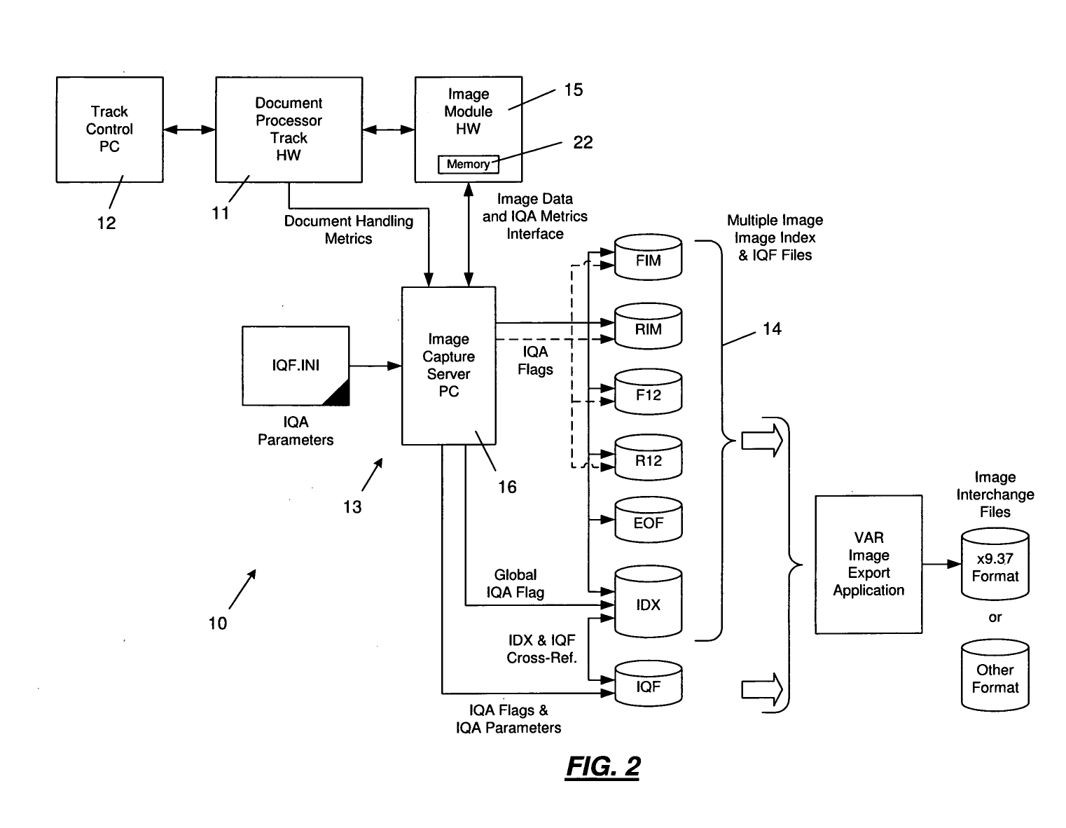

FIG. 2 is a block diagram illustration of subsystems in a document processing system 10 with an imaging subsystem 13. The document processing system 10 includes track hardware 11, a track controller or PC 12 for controlling the document movement along the track hardware 11, and the imaging subsystem 13 for capturing and processing electronic images of the documents being transported through the system 10, and for storing the captured images. The document processing system 10 may also include other subsystems, such as a MICR reading subsystem; an encoding subsystem (i.e., printing of additional information on the document); and/or a microfilming subsystem (for capturing a film image representation of the image of the document), and any other options and subsystems as known to those of skill in the art.

Operationally, documents are physically processed through the transport hardware 11 of the document processor under the control of track control PC 12. Track control PC 12 provides sorter control of the document transport hardware 11, and includes track applications, such as inclearings, proof of deposit, and remittance operations, and operating system software, which in one embodiment is WINDOWS NT®, WINDOWS 2000®, or WINDOWS XP®-based system software. Other embodiments may use operating systems including but not limited to UNIX, Mac OS and proprietary operating systems. The system software also may include Unisys Common Application Programming Interface, or CAPI, which is an application programming interface that enables the same application software to be used across multiple transport platforms. The image capture subsystem 13 provides image server and capture capabilities and interfaces with the document transport hardware 11 to receive images moved by document transport and to store them in appropriate files 14 (e.g., FIM, RIM, FI2, RI2). The image capture subsystem 13 generally comprises both hardware and software, including imaging module hardware 15, having a camera subsystem for capturing images, and an image capture server (ICS) PC 16 for processing and storing the images. The details of the document processing system 10 can have various forms, such as those described in U.S. Pat. No. 7,167,580 assigned to Unisys Corporation.

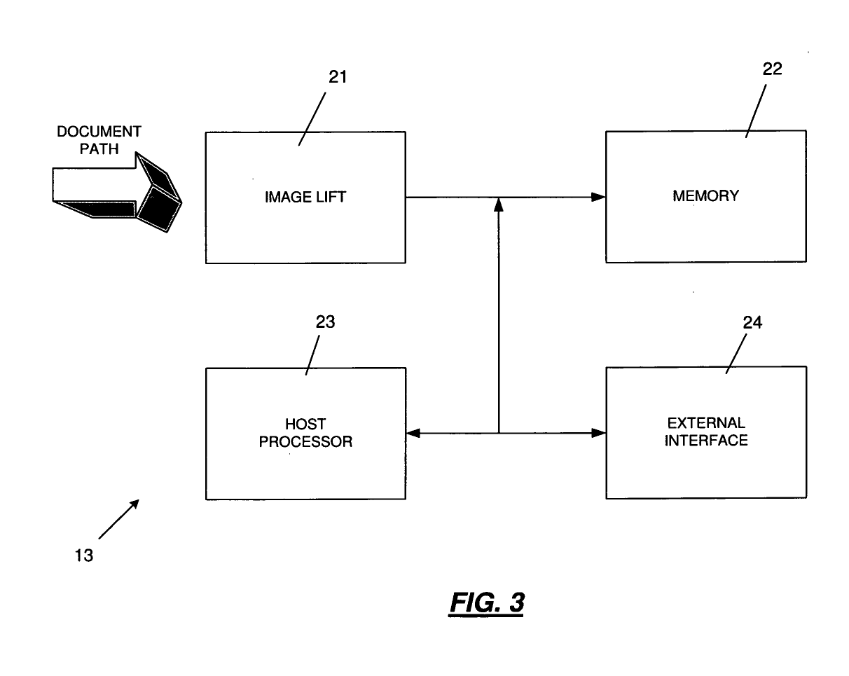

The image capture subsystem 13 of the document processing system 10 shown in FIGS. 1 and 2 may be functionally represented, at a high level, as shown in FIG. 3. The image capture subsystem 13 shown in FIG. 3 includes four basic blocks. However, it is noted that, as this is a functional representation, each block does not necessarily uniquely correspond to a separate device or component within the document processing system 10, but rather a defined function; thus these functions may span across more than one device or component at any given time.

Light reflected off of the document moving in the track 11 is reflected back and input to the image lift function 21. The image lift function 21 serves two basic functions. First it converts the light input reflected from the document into the camera subsystem into analog electrical signals and then digitizes them into a digital number representative of the physical brightness of an individual pixel. For example, 0 may represent pure black; 255 may represent pure white; and 1 thru 254 may represent various shades of gray that correspond to the light/darkness of an individual pixel. A scanned document will include a large number of such pixels. As an example, a document that is physically 6 inches wide by 3 inches tall when scanned at 200 dots per inch will consist of 6×200×3×200=720,000 pixels. In one embodiment, the image lift function 21 can be performed by a camera subsystem, which may be implemented in a camera printed circuit board.

It will be appreciated that the image capture subsystem 13 may not have a priori knowledge of the actual size of the document or exactly when it will pass through the document processing system 10. This is a second functionality that the image lift function 21 provides; that is, the image lift function 21 performs a document framing function. Document framing includes finding the right and left bounds of the document as it passes in front of the camera. For example, if a document is moving through the document track 11 and passing horizontally in front of a vertically oriented scanner used to detect the light level reflected back into the image lift function 21, the scanner should be physically tall enough to capture light from the tallest possible document that the document processing system 10 is designed to accommodate. However, it is not until the entire document has physically passed in front of the scanner that the image capture subsystem 13 is able to fully define the outermost boundaries of the electronic representation of the image. For this reason, the image lift function 21 typically has some form of memory storage, depicted in FIG. 3 as memory 22, associated with it to store the raw camera data as it comes in from the camera subsystem so that only the relevant portion that actually represents the document can be later processed. In one embodiment, the document boundary defining functionality of the image lift block 21 and the memory 22 are implemented on an image processor board in the image capture subsystem 13. Although one example of acquiring a digitized image is described, the artisan will recognize the alternatives, including those that correlate to portions of documents or the like.

After the image data has been stored in the memory 22, the processor function, depicted in FIG. 3 as host processor 23, performs analysis of the captured data in the memory 22 to determine the precise location of the image, and then compresses this image and sends it out through some external interface, depicted in FIG. 3 as external interface 24, for further processing and image storage (e.g., to the image capture server (ICS) PC 16). This same external interface 24 typically also controls the imaging subsystem 13; passing it parameters and enabling/disabling the image functionality as required by the document processing system 10. In one embodiment, the host processor 23 and the external interface 24 are also implemented on the image processor board in the image capture subsystem.

The memory 22 may comprise a memory integrated circuit having memory cells arranged in pages, such as a paged, DDR SDRAM (double-data-rate synchronous dynamic random access memory). Although DDR SDRAM is preferred, other examples of paged memory may include fast paged mode DRAM and EDO DRAM.

The DDR memory 22 in this embodiment has a page width of 2K (i.e., 2048 bytes) and the expected, maximum pixel width of the image, M, is 2K or greater. If no changes were made to the conventional transposition algorithm, every pixel written to the DDR memory 22 during capture would incur a page hit, while there would be excessive performance margins on the READ side where relatively no page hits occur. To balance this situation, during transposition the image processor partitions an M×N area of the memory 22 into a plurality of column groups, with each column group comprising a plurality of columns (e.g., 256 columns per group).

Control circuitry used to route pixel data from the Image Lift (21) to Memory (22) is designed in logic and may be implemented in an FPGA (Field Programmable Gate Array). The partitioning logic variously described herein is executed by controlling the memory write and memory read addressing. Write and read addresses are then routed to the DDR SDRAM controller, which may also be implemented in the FPGA, to store and fetch pixel data from the paged DDR.

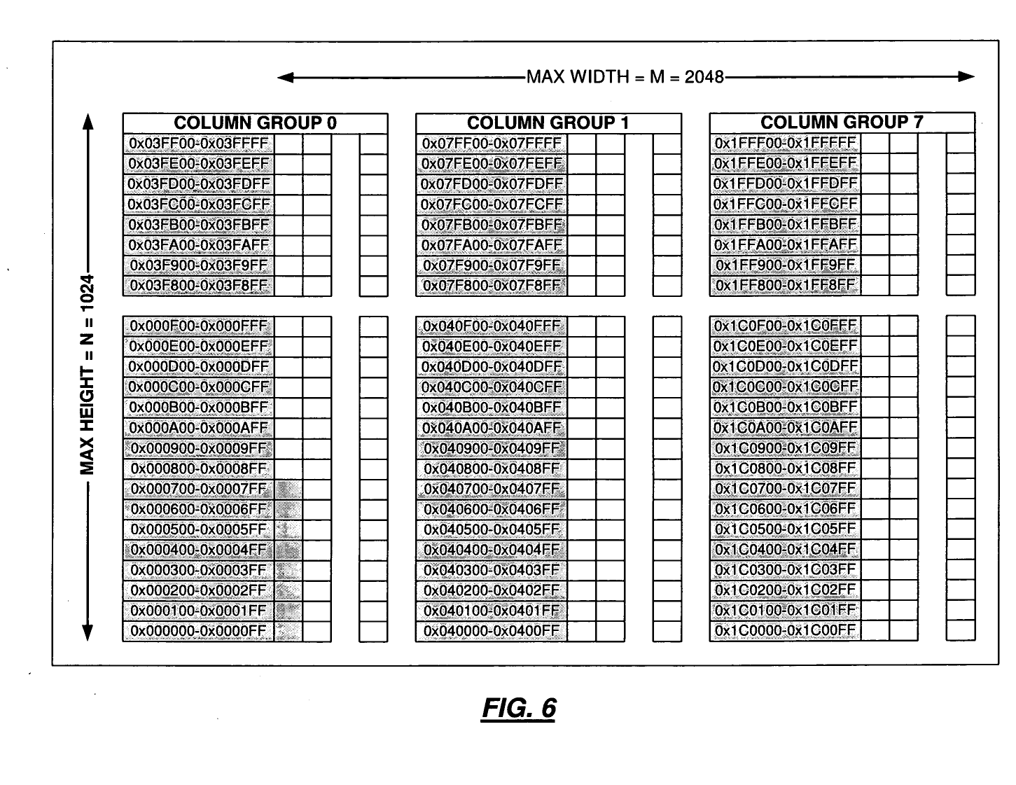

Write Operation. Referring to FIG. 6, an M (=2048)×N (=1024) section of memory has been partitioned into eight, 256 column groups. Because of this partitioning, pixels are written into memory in intervals of +256 instead of +M (2048). Hence, instead of every pixel crossing a 2K page, groups of 8 consecutive pixels will all fall on the same page. For instance, the first eight pixels of the image are written to addresses 0x000, 0x100, 0x200, 0x300, 0x400, 0x500, 0x600 and 0x700, respectively. All eight WRITES (shown shaded) are within a 2K, DDR page and will incur no penalty. There will be a penalty as the 9h pixel is written to address 0x800 but the next seven pixels will be written to addresses x900, xA00, xB00, xC00, xD00, xE00 and xF00 without penalty. With this partition-based transposition, the write performance is increased by a factor of 8 over the conventional transposition scheme.

Read Operation. According to this embodiment, rows no longer consist of 2048 consecutive pixels. Instead, the rows are arranged in 8 groups of 256 consecutive pixels with gaps of 256xN (x40000) between each group. Therefore, the READ portion of the transposition scheme can fetch 256 pixels before incurring DDR page hits, instead of being able to get all 2048 pixels in a row without penalty. Even though this would appear to be a READ performance degradation as compared to traditional schemes, the memory (with the transposition scheme) implemented according to this embodiment can still extract data faster than downstream image scaling and compression can process this data. Therefore, such READ performance degradation will not typically impose a negative affect on overall system performance. Also, the transposition scheme provides significant performance relief on the WRITE side at the minimal expense of READ performance, by offloading some of the WRITE side paging overhead to the READ side until desired system performance is achieved. Since the READ side paging already had significant margin to spare, there is minimal effect on system performance.

The WRITE performance can be increased even further by partitioning the M (=2048)×N (=1024) section of memory into sixteen, 128-column groups. With that configuration, bursts of sixteen pixels can be WRITTEN into DDR without crossing page boundaries. In some circumstances, 256 column groups will offer the best solution for the image processing system. Different systems having different memory configurations, scanning parameters, or other characteristics may dictate alternative partitioning parameters. Also, it is again noted that although this embodiment partitions a 2048x1024 section of memory other sizes may of course be provided. The ordinarily skilled artisan will readily recognize, or, through simulation or the like, may readily optimize partitioning for any system and any sectioning of memory.

Determining Top Left Pointer Location. In one embodiment, the data from the scan system is put into memory in a fashion that allows the system to achieve a higher throughput than a system that does not employ the column group approach. The control processor 16 in the system 10 is able to pull out the portion of the scanned image in the memory 22 that is of interest. This will be the full document from edge to edge with any overscan required to allow downstream image functions like scaling and compression to work properly. The hardware can be set to fill extra scan lines (e.g., 40 lines) after the document to allow these downstream image functions to work on up to 40 pixel wide boundaries.

The direction of scan influences the reference pointer to determine the left corner of the transposed image to be compressed. When the scanning is done in the left to right direction, the upper left corner of the image memory is located at the top of the first column group. When scanning in the right to left direction, the upper left corner of the image memory is found in the last column group within 256 bytes of the end. This depends on the number of columns in the image. The desired top location can be moved to the location corresponding to the top row of the image by the calculation below:

TopLeftDesired=PtrMaxTopLeftLocation−(ColumnGroupWidth*((MaxHeightN−1)−TopRowOfImage)

The following additional calculations may be used to calculate the actual pointer to the left corner of the image to be compressed in the right to left direction. From this pointer location, the pointer is moved the appropriate number of columns to skip over any data which is not part of the desired image as a result of hardware data overscan.

The difference in width between the actual width captured and the desired image width is calculated as follows:

WidthDifference=TotalCapturedWidth—DesiredImageWidth

This width difference will modify the TopLeftDesired position in one of two ways. These two ways depend on the amount of columns in the last column group after the entire image has been captured. The formula for determining this value is:

The remainder of:(TotalCaptureWidth−1)/ColumnGroupWidth Or, simply, (TotalCaptureWidth−1)&(ColumnGroupWidth−1)

If this value is less than or equal to the WidthDifference, then an entire column group needs to be moved, and the pointer needs to be positioned in this column group. The TopLeftDesired position would be moved to the right by the formula:

TopLeftDesired=TopLeftDesired+((ColumnGroupWidth*MaxHeightN) (ColumnGroupWidth−1)+WidthDifference)

Otherwise the pointer is just moved by the amount of the width difference:

TopLeftDesired=TopLeftDesired+WidthDifference

### The TopLeftDesired location can then be used by the hardware to pull out the transposed image.

In one embodiment, the DDR is a Micron 512 Mb DDR SDRAM, commercially available from Micron Technologies, and the DDR core/controller is a DDR2 SDRAM Controller Version 3.2.1 from the Megacore IP Library, which is downloadable from Altera Corporation. The paging performance using the Micron DDR and Altera IP DDR controller, based on simulation, is as follows:

1) Micron DDR performance, 9 clock cycles of overhead for every Double word (32 bits) Read or Write on a new, 2K page; and,

2) Micron DDR performance, 1 clock cycle for every Double word (32 bits) Read or Write within a 2K page.

In an imaging system using the conventional transposition scheme, a raster scanned image was READ from memory in MAX_WIDTH, horizontal rows (every 2048 pixels in a MAX_WIDTH row are on the same DDR page). The performance was as follows:

WRITE SIDE 9 CYCLE, PAGING OVERHEAD—once for every 1 WRITE to DDR; and

READ SIDE 9 CYCLE, PAGING OVERHEAD—once for every 2048 READS from DDR.

In an imaging system using the transposition scheme, a vertically scanned image can be captured and written into memory in 256 address increments (every 8 writes cross a DDR page boundary), and the raster scanned image can be READ from memory in MAX_WIDTH, horizontal rows (every 256 pixels in a MAX_WIDTH row are on the same DDR page). The following performance can be achieved:

WRITE SIDE 9 CYCLE, PAGING OVERHEAD—once for every 8 WRITE to DDR

READ SIDE 9 CYCLE, PAGING OVERHEAD—once for every 256 READS from DDR

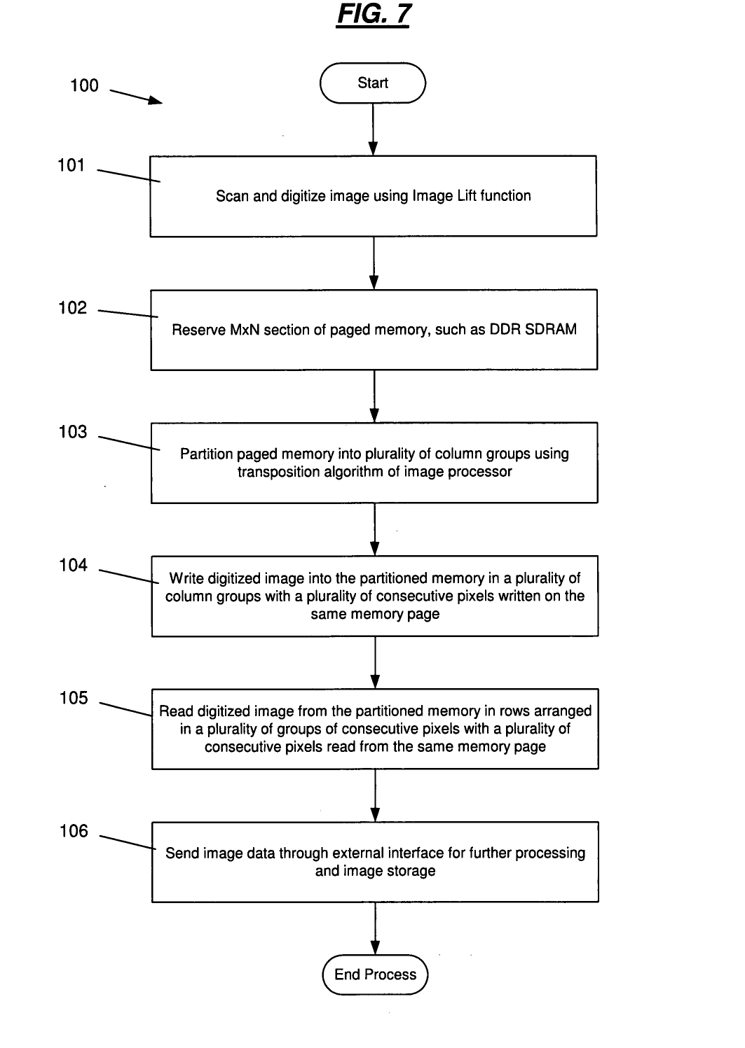

FIG. 7 is a flow diagram illustrating an embodiment of a method 100 for capturing and transposing scanned images in an imaging system. In the first step 101, the documents are scanned and digitized using the image lift function 21. An M×N section of the paged memory 22, such as DDR SDRAM, is then reserved (102). The paged memory 22 is then partitioned 103 into a plurality of column groups using a transposition algorithm of the image processor. The digitized image is written 104 into the partitioned memory in a plurality of column groups with a plurality of consecutive pixels written on the same memory page. The image is read 105 from the partitioned memory in rows arranged in a plurality of groups of consecutive pixels with a plurality of consecutive pixels read from the same memory page. The image data read from the memory 22 is then sent 106 through an external interface for further processing and image storage.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically illustrated or described in detail to avoid obscuring aspects of embodiments of the present invention.

The embodiments of the present invention produce and provide systems and methods for capturing and transposing vertically scanned documents in an imaging system. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. An imaging system, comprising:
a means for scanning and digitizing an image;
a paged memory into which the digitized image can be written in a series of columns and from which the image can be read in a series of rows; and
a means for partitioning the paged memory into a plurality of column groups so that a plurality of consecutive pixels for the digitized image can be written on the same memory page.

2. The imaging system according to claim 1, wherein said paged memory comprises DDR SDRAM.

3. The imaging system according to claim 1, wherein said means for partitioning the paged memory creates rows arranged in a plurality of groups of consecutive pixels with gaps between each group.

4. The imaging system according to claim 1, wherein the digitized image is transposed before it is written on the paged memory.

5. The imaging system according to claim 1, further comprising a means for reading the image from the paged memory and sending the image through an external interface for further processing and image storage.

6. The imaging system according to claim 1, wherein said paged memory comprises DDR SDRAM, and wherein an expected maximum pixel width M of the image is equal to or greater than a page width of the DDR SDRAM.

7. The imaging system according to claim 1, further comprising a means for reserving an M×N section of said paged memory before writing the image into the memory, where M is the maximum expected width of the image, and N is the maximum expected height of the image.

8. The imaging system according to claim 7, wherein said paged memory comprises DDR SDRAM, and wherein the maximum expected width M of the image is equal to or greater than a page width of the DDR SDRAM.

9. The imaging system according to claim 8, wherein said means for partitioning the paged memory partitions the memory into at least eight column groups so that groups of at least eight consecutive pixels can be written on the same memory page.

10. The imaging system according to claim 9, wherein said means for partitioning the paged memory creates rows arranged in at least eight groups of a plurality of consecutive pixels with gaps between each group.

11. A method of capturing and transposing an image, comprising:
scanning and digitizing an image to provide a digitized image;
writing the digitized image into a paged buffer memory in a plurality of column groups so that a plurality of consecutive pixels are written on the same memory page; and
reading the digitized image from the paged buffer memory in a series of rows arranged in a plurality of groups of consecutive pixels so that a plurality of consecutive pixels are read from the same memory page.

12. The method according to claim 11, wherein said paged buffer memory comprises DDR SDRAM.

13. The method according to claim 11, wherein the digitized image is transposed before it is written on the paged memory.

14. The method according to claim 11, further comprising sending the digitized image through an external interface for further processing and image storage.

15. The method according to claim 11, wherein said paged memory comprises DDR SDRAM, and wherein an expected maximum pixel width M of the image is equal to or greater than a page width of the DDR SDRAM.

16. The method according to claim 11, further comprising reserving an M×N section of said paged memory before writing the image into the memory, where M is the maximum expected width of the image, and N is the maximum expected height of the image.

17. The method according to claim 16, further comprising partitioning the paged memory into a plurality of column groups so that a plurality of consecutive pixels are written on the same memory page.

18. The method according to claim 17, wherein the paged memory is partitioned into rows arranged in a plurality of groups of consecutive pixels with gaps between each group.

19. A system for partitioning a paged memory to accommodate transposed image files, the system comprising:
a processor;
memory, storing instructions that are executed by the processor to receive a digitized image, configure access to a paged memory into which the digitized image can be written in a series of columns and from which the digitized image can be read in a series of rows, and partition the paged memory into a plurality of column groups so that a plurality of consecutive pixels for the digitized image can be written on the same memory page of the paged memory.

20. The system according to claim 19, wherein an image is scanned to provide the digitized image.

21. The method according to claim 20, wherein the digitized image is transposed before it is written on the paged memory.

22. The system according to claim 19, wherein the stored instructions are also executed to read the digitized image from said memory cells in a series of rows arranged in a plurality of groups of consecutive pixels so that a plurality of consecutive pixels can be read from the same memory page.

23. The system according to claim 19, wherein the paged memory comprises DDR SDRAM.

24. The system according to claim 19, wherein the paged memory is partitioned to provide at least eight column groups so that groups of at least eight consecutive pixels can be written on the same memory page.

25. A method for partitioning a paged memory to accommodate transposed image files, the method comprising:
receiving a digitized image;
accessing a paged memory into which the digitized image can be written in a series of columns and from which the digitized image can be read in a series of rows; and
partitioning the paged memory into a plurality of column groups so that a plurality of consecutive pixels for the digitized image can be written on the same memory page of the paged memory.

26. The method according to claim 25, wherein an image is scanned to provide the digitized image.

27. The method according to claim 26, wherein the digitized image is transposed before it is written on the paged memory.

28. The method according to claim 25, wherein the stored instructions are also executed to read the digitized image from said memory cells in a series of rows arranged in a plurality of groups of consecutive pixels so that a plurality of consecutive pixels can be read from the same memory page.

29. The method according to claim 25, wherein the paged memory comprises DDR SDRAM.

30. A computer program product comprising instructions for partitioning a paged memory to accommodate transposed image files stored on a computer readable medium, the instructions being executable to provide partitioning that comprises:
receiving a digitized image;
accessing a paged memory into which the digitized image can be written in a series of columns and from which the digitized image can be read in a series of rows; and
partitioning the paged memory into a plurality of column groups so that a plurality of consecutive pixels for the digitized image can be written on the same memory page of the paged memory.

31. The computer program product according to claim 30, wherein an image is scanned to provide the digitized image.

32. The computer program product according to claim 26, wherein the digitized image is transposed before it is written on the paged memory.

33. The computer program product according to claim 25, wherein the stored instructions are also executed to read the digitized image from said memory cells in a series of rows arranged in a plurality of groups of consecutive pixels so that a plurality of consecutive pixels can be read from the same memory page.
